(19) United States
(12) Patent Application Publication
(10) Pub. No.: US 2007/0299639 A1
(43) Pub. Date: Dec. 27, 2007

(54) Direct Volume Rendering with Shading

(75) Inventors: Juergen Weese, Aachen (DE); Gundolf Kiefer, Aachen (DE); Marc Busch, Aachen (DE); Helko Lehmann, Aachen (DE)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS N.V., EINDHOVEN (NL)

(21) Appl. No.: 11/573,795

(22) PCT Filed: Jul. 27, 2005
(86) PCT No.: PCT/IB05/52519

§ 371 Date: Feb. 16, 2007

(30) Foreign Application Priority Data
Aug. 31, 2004 (EP) 04300565.1

(51) Int. Cl. G06F 7/60

(52) U.S. Cl. 703/2

(57) ABSTRACT

The present invention relates to direct volume rendering based on a light model applied to a 3D array of information data samples. Gradients are first estimated for the individuals samples, and a simple shading is done on the samples with low gradient, i.e. homogenous areas.

### FIELD OF THE INVENTION

The present invention relates to data processing. The invention is particularly pertinent to direct volume rendering and visualization of 3D images in the medical domain.

### BACKGROUND OF THE INVENTION

Direct Volume Rendering (DVR) is a direct method of obtaining two-dimensional images of a three-dimensional data set. Other techniques exist to generate 2D images, e.g. maximum intensity projection, slicing, iso-surface visualization but these known techniques are limited in that only some of the 3D data values contribute to the final 2D result. In direct volume rendering, the whole set of data has the potential to contribute to the 2D output image. Direct volume rendering thus provides a projection of the volume into the display window and although there may be ambiguity as to the depth of some regions of visualization, interactivity allows the user to manipulate the viewpoint and viewing angle and get a better feel of the viewed object and its volume. Whereas other image processing algorithms are based on pixels, DVR deals with voxels, 3D analogue of 2D pixels. A variety of direct volume rendering methods exists, but all are based around the idea that voxels are assigned a color and a transparency mask. This transparency parameter means that obscured voxels may still contribute to the final image though to a lesser extent. This mechanism allows direct volume rendering to display an entire 3D data set, including the internal structure viewed by variation of opacity values assigned to body shells and body surfaces.

Direct volume rendering methods use look-up tables on image gray values to assign opacity values to image voxels. Using the opacity look-up tables and the gradient information derived at the sample location, a contribution to the final rendering is computed using a light model or shading model. The Phong shading model is a standard reflection model widely used in computer graphics designs. It represents the interaction of light with a surface at a sample point. The Phong model defines the contribution of a sample point in terms of diffuse and specular components together with an ambient term. The intensity of a point on a surface is a linear combination of these three components. In practice, the depth relative to the viewpoint is also taken into account and the contribution of a sample point may be a weighted sum of the depth component, the ambient component, the diffuse component and the specular component.

Computation of the overall contributions can be rather heavy for large 3D data sets and much processing power may be wasted for homogeneous areas. These areas do not play a key role in the final picture and relatively to picture areas with objects boundaries, less processing would be ideally spent. In addition, noise in the homogeneous areas may cause undesired disturbing patterns, which may lead to a blurring of the image. Following this observation, the industry has developed computational solutions that offer a trade off between image quality and display speed.

One feasible solution is described in the following paper “Direct Volume Rendering with Shading via Three-Dimensional Textures” Allen van Gelder, Kwansik Kim, 1996, IEEE, hereby incorporated by reference. This paper describes a method for direct volume rendering that uses 3D texture maps and that incorporates directional lighting. It develops a gradient-based shading criterion in which the gradient magnitude is interpreted in the context of the field-data value and the material classification parameters. First, the quantized gradient index and material classification of each voxel in the volume are computed. A voxel may be classified as either reflecting or ambient, depending on a client-supplied gradient-magnitude threshold. An index is thus determined for each voxel in the look-up table. With the pre-assigned look-up table index of each voxel, 3D texture maps are filled with pre-computed color values. Each texture map entry corresponds to one voxel. Its color is the sum of ambient and reflecting components. The reflecting component is based on a surface responding to directional light, and only applies to parts of the volume judged to represent the boundary surface between different materials. Thus, this gradient-based shading method takes off the reflecting component for areas with low gradient, i.e. non-boundaries areas. This alters the optical appearance of these areas, however, in order to perform such rendering, the gradient still had to be calculated for every sample location in the volume data set.

### SUMMARY OF THE INVENTION

Among other goals, the invention aims at speeding up direct volume rendering with minimized impact to the picture quality. Additionally, in one or more embodiments of the invention, the proposed method improves the overall image rendering.

To this end, a method of applying a light model to a three-dimensional array of information data samples is presented. The light model is represented by a mathematical function of a gray value parameter and a gradient parameter. The method first prescribes to compute a gradient estimate representative of a gradient's magnitude of a sample and the obtained estimate result is then compared with a threshold. If the gradient estimate falls below the threshold, the contribution of the sample to the final result of direct volume rendering based on the light model is set to a uniform contribution value.

Direct volume rendering uses light models to compute the contribution of information data sample to the final picture. As disclosed above, the contribution is often a sum of two or three components. The choice of the components that will be used in the final computation may vary from a light model to another and among implementations. The prior art solution suggests that the light model is switched during computation depending on a gradient-based criterion and the resulting classification of the voxel (reflecting or not). The invention proposes a different solution. In the invention, the computation is based on the same light model and the same light model components for the whole picture and a characteristic is that a shading is applied to some picture areas.

The contribution of a sample is determined based on a gradient estimate value. In an exemplary embodiment, the gradient estimate is the actual gradient calculated for the information data sample. Alternatively, the gradient estimate may be an approximation of the gradient, which provides a quick and rough estimation of the actual gradient value. No time is thus wasted on the samples classification. The contribution of each sample to the final result varies depending on the computed gradient estimate value. If the estimate value lies below a threshold, the contribution is set to a uniform value. In one or more embodiments, the uniform value is determined by integrating the mathematical function of the light model over all gradient directions. This corresponds to a smooth shading of areas with lows gradient values. The term sample conventionally refers to voxels that represent volume elements, or interpolated intensity values between the discrete voxel locations.

An advantage of the invention is to simplify computations in picture areas with low gradients where the information is similar and slowly varying. Homogenous areas are often areas that present the least interest to the final rendering and data within these areas is so slowly varying that replacing exact computation results with uniform value may not alter the final result and the user's overall perception of the display. Conversely, user's perception may be improved because the simplified contribution calculation of the invention will be less affected by noise than a more complex full calculation. The invention both improves the overall user perception of the display and at the same time reduces the computational complexity and thereby increases the display speed.

In another embodiment, an additional gradient-based criterion is introduced to smoothen the transition between samples located in what's referred to as homogenous areas and areas with high gradient values. Samples with high gradients are often found in the vicinity of boundary surfaces between objects or different materials. The gradient estimate is compared with a second threshold and if the estimate value lies between the first and the second threshold, the contribution is set to a combination of the light model function derived for the exact gradient value and the previous contribution uniform value.

The invention also relates to a corresponding device and corresponding record carrier storing instructions for performing same.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a screen image of a 3D object;

FIG. 2 is a screen image of a 3D object of the invention;

FIG. 3 is a flow-chart diagram illustrating a method of the invention; and,

FIG. 4 is a screen display of a 2D slice of a 3D object of the invention.

Throughout the drawing, the same reference numeral refers to the same element, or an element that performs substantially the same function.

### DETAILED DESCRIPTION

The invention will be described in the context of medical images however one should not limit the scope of the invention to medical applications. The invention clearly encompasses any type of application, which uses the features of the invention, though in remote technical fields where 3D arrays of data are used. For example, the invention would be beneficial to other field like video gaming, meteorology and aeronautic, etc . . .

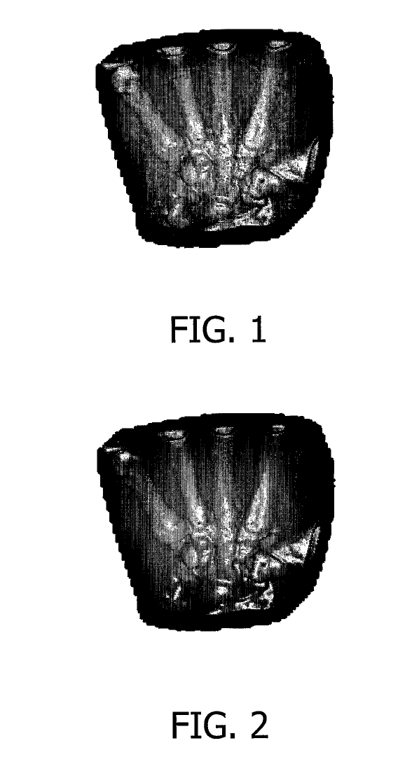

FIG. 1 and FIG. 2 represent displays of the internal bone structure of a human hand. The two displays show the fingers' bones skeleton, and the hand's tissue shows up as dark homogenous areas. Homogenous areas are referred as such in contrast with areas where the body structure changes (e.g. bone surfaces boundaries). Both images are based on the same original set of data, obtained for example by X-ray radiation of the person's hand but this original set of data is handled in two different manners and consequently, the displays differ in quality. The display of FIG. 1 is obtained when a data processing algorithm of the prior art is applied to the original set of data whereas the display of FIG. 2 is obtained when an algorithm of the invention is applied to the original set of data. The obvious difference between the two displays is the overall appearance of the homogenous regions. In the image of FIG. 1, a noticeable noise blurs these portions, taking the form of lighter clouds in the dark regions. This blurring is due to noise. When an algorithm of the invention is applied to the original set of data, a smooth uniform result is obtained and the frontiers between body materials, e.g. boundary blood/bone, are more clearly marked as seen in FIG. 2.

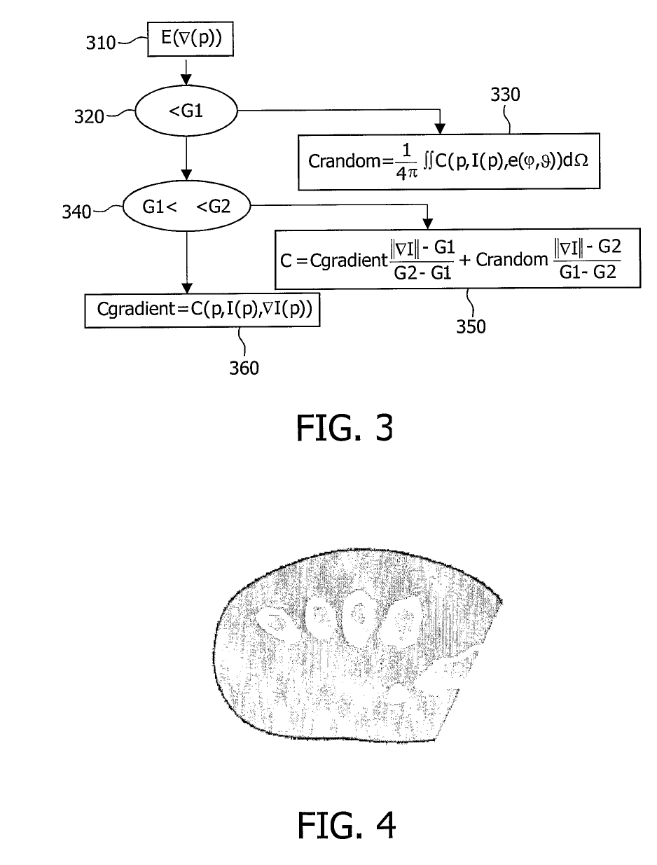

FIG. 3 is a flowchart diagram giving steps of an exemplary algorithm of the invention. An initial set of data is received and processed. The initial set is a three-dimensional array of information data samples. Each data sample may be associated with volume elements or voxels of a 3D image representing a 3D environment including 3D objects. The terms samples or voxels may be used indiscriminately to refer to the individual elements of the 3D array of data although voxels typically refer to discrete positions whereas samples may be interpolated values referring to any position with potentially non-integer coordinates. The samples may be color values, physical measurements values, e.g. radiation absorption levels, global radiation levels observed at some points in space, temperature values and the like. The invention provides a manner to determine individual contributions C of 3D data samples to the calculation of a light model in direct volume rendering. Each information data sample of the 3D array contributes to the final 2D image and a known light model is used to determine these individual contributions C. In the invention, the light model is a mathematical function based on two main parameters: the sample gradient and the gray value.

In a first step 310, a gradient estimate value is determined for at least one of the sample. The estimate is either an exact gradient calculation or an approximation of the exact gradient value. If an approximation calculation is chosen, a rough gradient calculation permits to eventually save time on precise exact gradient calculation as will be seen hereinafter. The obtained gradient estimate value is then compared with two thresholds G1 and G2. The thresholds G1 and G2 may be set beforehand by designers of the display device or may be left to the user's choice, who thereby has a possibility to visually fine tune the display in real time. The gradient estimate is first compared with the smallest threshold G1 in step 320. If the gradient estimate is smaller than the threshold G1, the contribution C is set to a uniform value C_{random} in step 330. For example, the uniform gradient value may be derived from the following equation:

$$Crandom = \frac{1}{4 π} \int \int C ( p , I ( p ) , e ( φ , ϑ ) ) ⅆ φ ⅆ ϑ$$

The value C_{random} is obtained by integrating the contribution function over all volume directions limited to the homogenous area. Hence, areas with low gradient, i.e. homogenous areas, will appear as non-noisy uniform areas.

If the gradient estimate is greater than threshold G1, it is compared in step 340 with the second threshold G2. If the comparison shows that the gradient estimate has a value greater than G2, i.e. the sample has a high gradient, the information data sample is likely to be in the close vicinity of a physical boundary such as a bone surface or an organ surface. The contribution to direct volume rendering is thus determined in step 360 from the mathematical function of the light model mentioned above. The function may be used on the basis of either the gradient estimate or the exact gradient of the sample. Little deviation from the function is permitted in high gradient areas, because preciseness is greatly needed at boundaries and the use of a gross approximation of the gradient or a simplification of the chosen light model would introduce a blurring effect or a shading effect at boundaries.

If the gradient is within the range [G1; G2], the contribution to direct volume rendering is a combination of the contribution calculated with the original mathematical function of the light model and the uniform contribution C_{random} as seen in step 350. The contribution can be derived as follows:

$$C = Cgradient \frac{‖ ∇ I ‖ - G 1}{G 2 - G 1} + Crandom \frac{‖ ∇ I ‖ - G 2}{G 1 - G 2}$$

∥∇∥ is the gradient's magnitude of the sample in question. This third calculation formulae provides a smooth transition between homogenous areas (low gradients) and boundaries and thus leads to a better image appearance.

Other embodiments of the invention do not include the comparison with threshold G2 and thus, do not include steps 340 and 350.

FIG. 4 is a 2D slice of a 3D data set and represents another experimental display result of the hand of FIG. 2 using direct volume rendering where an algorithm of the invention has been applied. One can observe that homogenous areas such as the inside of the fingers, the bones themselves and the outside are uniformly displayed without any undesired patterns due to noise in these regions.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

The invention does not impose any restriction on the values of the various parameters mentioned above, e.g. the thresholds and these parameters may be changed in real time if needed. For example, one may contemplate an embodiment where thresholds G1 and G2 can be modified to improve the overall picture rendering.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method of applying a light model represented by a mathematical function of a gray value parameter and a gradient parameter to a three-dimensional array of information data samples to determine individual contributions to direct volume rendering of the three-dimensional array, the method comprising:
computing a gradient estimate representative of a gradient's magnitude of a sample;
comparing (the gradient estimate with a threshold;
if the gradient estimate is below the threshold (330), a contribution of the sample to direct volume rendering based on the light model is set to a uniform contribution value.

2. The method of claim 1, characterized in that the uniform contribution value is obtained by integrating the mathematical function over all gradient directions.

3. The method of claim 1, wherein the gradient estimate is obtained from an exact gradient calculation of the sample.

4. The method of claim 1, wherein the gradient estimate is obtained from an approximation calculation of the sample's gradient.

5. The method of claim 1, wherein the method further comprises:
further comparing the gradient estimate with a second threshold valued; if the gradient estimate is between the first and the second thresholds, the sample's contribution to the light model is determined from a combination of the mathematical function calculated on the basis of the exact sample's gradient value and of the uniform contribution value.

6. A device comprising:
storage means for storing a three-dimensional array of information data samples;
a processing arrangement for computing individual contributions of the data samples to direct volume rendering based a light model represented by a mathematical function of a gray value parameter and a gradient parameter characterized in that the processing arrangement is configured to compute a gradient estimate representative of a gradient's magnitude of a sample and after comparison of the gradient estimate with a threshold, sets a contribution of the sample to direct volume rendering based on the light model to a uniform value if the gradient estimate is below the threshold.

7. A record carrier for storing computer executable instructions for carrying out a method of claim 1.
